(19) United States
(12) Patent Application Publication
(10) Pub. No.: US 2016/0369473 A1
(43) Pub. Date: Dec. 22, 2016

(54) CLOSURE, PARTICULARLY FOR CLOSING CONSTRUCTION AND TECHNOLOGICAL APERTURES

(71) Applicant: BERNDORF BADERBAU s.r.o., Bystrice nad Olsi (CZ)

(72) Inventor: Rudolf Cieslar, Milikov u Jablunkova (CZ)

(73) Assignee: BERNDORF BADERBAU s.r.o., Bystrice nad Olsi (CZ)

(21) Appl. No.: 15/184,160

(22) Filed: Jun. 16, 2016

(30) Foreign Application Priority Data
Jun. 18, 2015 (CZ) PUV 2015-31222
Jun. 18, 2015 (CZ) PV 2015-408

(51) Int. Cl. E02D 29/14; E05C 3/00; E05C 3/14; E05B 65/00

(52) U.S. Cl. CPC E02D 29/1427; E05B 65/006; E05C 3/006; E05C 3/14

(57) ABSTRACT

A closure, particularly for closing construction and technological apertures, the principle of which consists in that on the bottom side of the cover of the closing hole a rocker arm is pivotally mounted, the functional part of which in the closed position of the cover rests on the opposite element, which is anchored in the closing hole. The rocker arm is pivotally attached on a pin that is anchored by means of brackets to the bottom part of the cover. The axis of the pin, on which the rocker arm is mounted, may be either parallel to the longitudinal axis of the closing hole or perpendicular to it. The rocker arm and the rocker lug are balanced relative to the pin so that the closure is maintained in a closed position.

### TECHNICAL FIELD

The invention relates to a closure intended for closing or covering all construction and technological apertures, for the use in dry areas, but especially in areas under water, i.e. for example in septic tanks and pools.

### STATE OF THE ART

For Closing covers of construction and technological apertures, usually the principle of a bolt and screw in the flange of an opposite plate or a bayonet key principle of a bayonet lock on the opposite plate are used.

The technical problem consists in the fact that bolted joints, or bolts, are often in a wet environment or in an environment that is flooded. It follows that subsequent handling during unscrewing, or re-screwing with a screwdriver, a wrench or Allen wrench is very time-consuming and often uncomfortable for the operator when working underwater. At the same time, a considerable problem arises from the surface oxidation of bolted joints, which often leads to bolt breakage, and the consequent lengthy repair. Simultaneously, the same problem is connected with the fit of openings in the cover into the axis of the threads in the opposite plate. It is therefore very hard to ensure the alignment of the screws with threads. It sometimes happens that due to the misalignment of the screw against the thread, the threads are destroyed and thus unusable for further anchoring.

### SUMMARY OF THE INVENTION

The object of the present invention is to alleviate the disadvantages of the above problems. This object is met by the present invention for closing construction and technological holes on a different principle, which is characterized in that on the bottom side of the cover of the closing hole a rocker arm is pivotally mounted, the functional part of which in the closed position of the cover rests on the opposite element, which is anchored in the closing hole. The rocker arm is pivotally attached on a pin that is anchored by means of brackets to the bottom part of the cover. The axis of the pin, on which the rocker arm is mounted, may be either parallel to the longitudinal axis of the closing opening or perpendicular to it. The rocker arm and the rocker lug are balanced relative to the pin so that the closure is maintained in a closed position.

The rocker arm itself is provided with an arm which in the open position abuts on the bottom wall of the cover, as well as with a lug, the functional part of which abuts is in the dosed position of the cover on the opposite element. A spring can be connected to the lug for locking the lug in the dosed position. The functional part of the lug of the rocker arm is inclined, so as to provide a self-locking connection with the opposite element in the dosed position of the closure.

The closure according to the invention allows an easy, quick and repeatable closing of any technology apertures and its advantages are particularly apparent by apertures in areas under water, i.e. for example in septic tanks and pools. In these cases, the closing of apertures for example by means of a screw is very uncomfortable and not only during repeated opening and closing a thread damage may occur.

The closure according to the invention can reliably close the opening, which may be formed in horizontal or vertical walls of the technological objects.

### BRIEF DESCRIPTION OF THE DRAWINGS

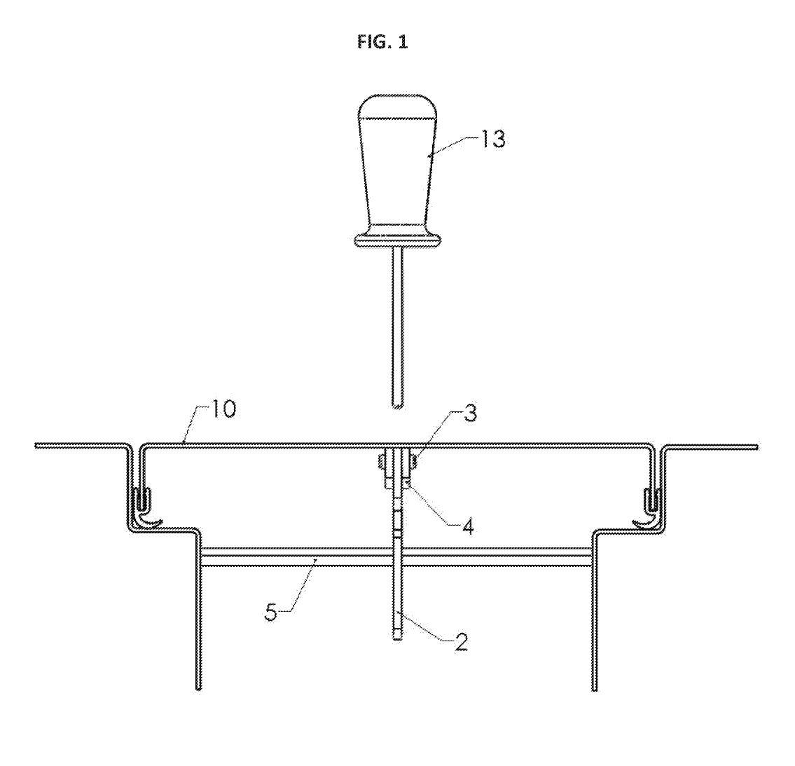

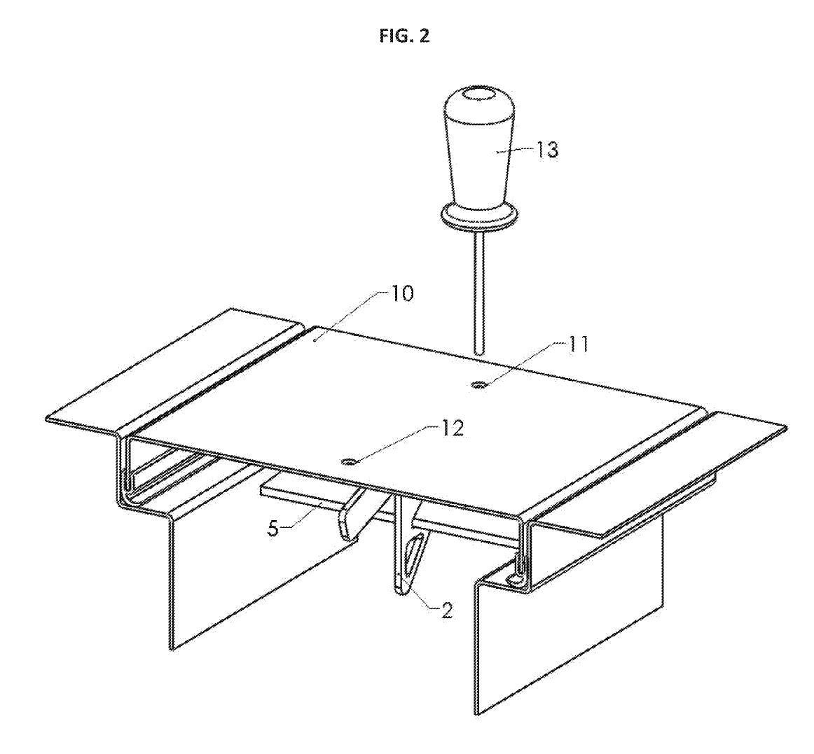

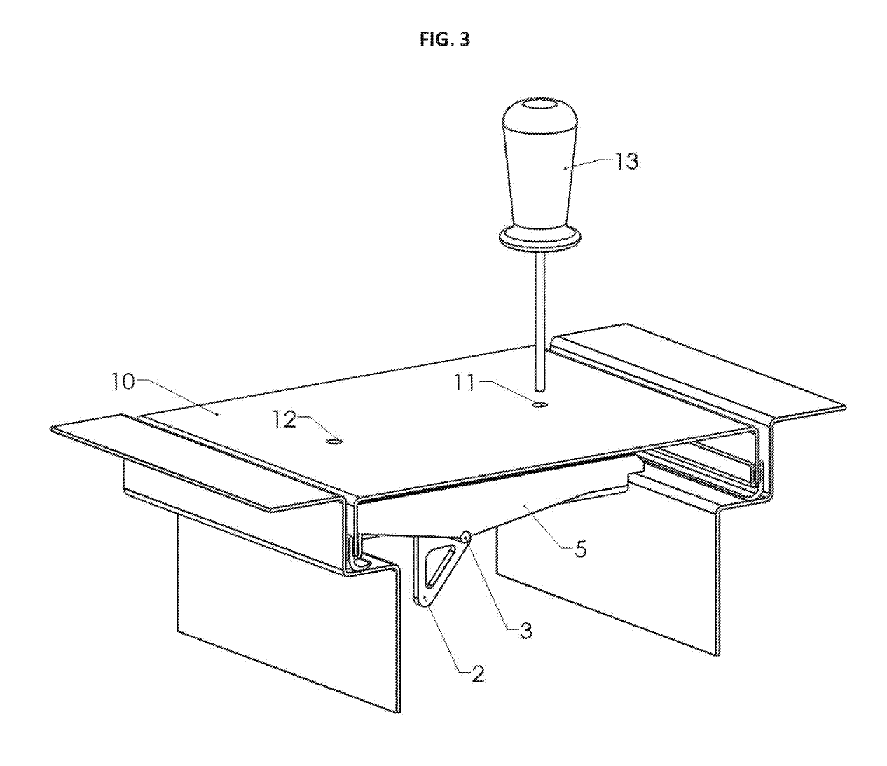

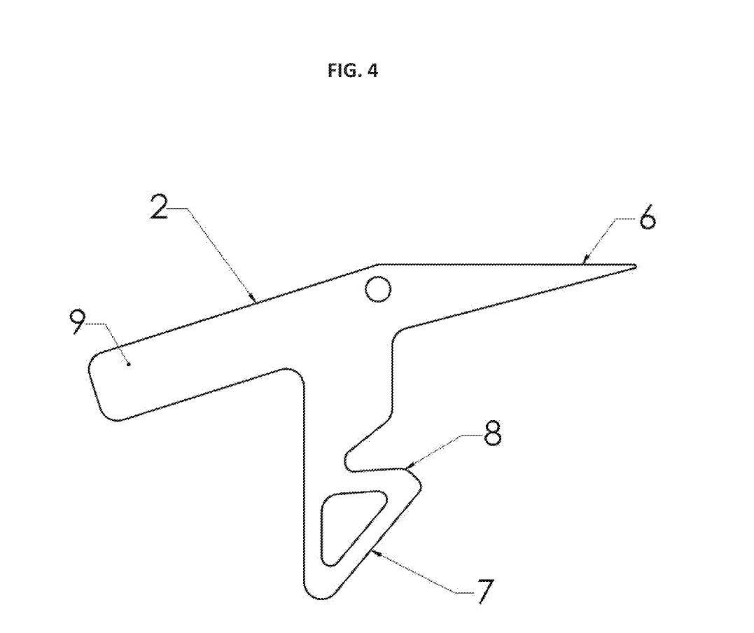

An exemplary embodiment of the closure according to the invention is illustrated in the accompanying drawings, wherein the FIG. 1 shows a schematic solution of the mechanism of the closure, wherein the axis of the pivot of the rocker arm is perpendicular to the axis of the closing opening, the FIG. 2 shows the closed opening from above with the mechanism showed in the FIG. 1, the FIG. 3 shows a schematic solution an alternative embodiment of the closure mechanism, wherein the axis of the pivot of the rocker is parallel to the axis of the closing opening and allows even the mounting on a vertical wall, and the FIG. 4 shows a separate rocker arm with a lug.

### EXAMPLE OF AN EMBODIMENT ACCORDING TO THE INVENTION

The invention of the closure is based on the function of a rocker arm 2, which is provided with an opening through which a pin 3, which is firmly anchored by means of brackets 4 of the pin 3 on the bottom wall of the cover of the closing hole. The closing hole may be both in a horizontal and in a vertical plane or also in a plane inclined, and any such solution is the part of this utility model. The brackets 4 are on the bottom side of the cover fastened usually permanently, mainly by welding, or detachably, thus, for example by means of a bolt and a nut. It is advantageous if the pin 3 and the brackets 4 of the pin are separated from the rocker arm 2 by an insulating layer. The actual rocker arm 2 and the two brackets 4 of the pin are made of precisely cut thick sheet of required shape.

The rocker arm 2 is provided with an arm 6, which in the open position of the closure rests on the bottom wall of the cover 10, and with a lug 7, the function part 8 of which in the closed position of the cover 10 rests on the opposite element 5. The arm 6 of the rocker arm 2 is structurally made so as to slide in the prescribed position under the opposite element 5 and to create together a solid closure. The opposite element 5 may be provided on the bottom part appropriately even with a ratable touch 14 to facilitate a relative movement between these parts of the mechanism.

The arm 6 of the rocker arm 2 and the lug 7 of the rocker arm 2 are relative to the pin 3 balanced so that the closure is maintained in a closed position. A spring can be connected to the lug 7 for locking the lug 7 in the closed position. The functional part 8 of the lug 7 of the rocker arm 2 is inclined, so as to provide a self-locking connection with a opposite element 5 in the closed position of the closure.

A cover 10 of the blocking aperture 1 is provided with a closing hole 12, which by means of a key 13 allows dosing the closure, and with an opening hole 11, which allows its opening. The opening hole 11 is positioned above a lever 9 of the rocker arm 2 and the closing hole 12 is located above the arm 6 of the rocker arm 2.

The lug 7 of the rocker arm 2 is provided with an entering inclined functional part 8, which while pushing the cover 10 onto the technological opening, allows to be deflected into the closed position of the lug 7 without using a cylindrical thrust key 13. The cylindrical thrust key 13 thus being applied only in the case of the complete closure of the lug 7 of the rocker arm 2 under the opposite element 5 or in the case of its reopening.

As far as the shape and weight are concerned, the rocker arm 2 is made so as to have the center of gravity on the side of the lever 9 of the rocker arm 2. The rocker arm 2 is thus pushed by means of the gravity force into the closed position. To rotate the rocker arm 2 to the open position is thus necessary to overcome the gravitation force of the gravity center of the rocker arm 2. The gravity center of the rocker arm 2 is made so that the gravitation forces act on the rocker arm both in the vertical position and in the horizontal position. This feature enables to lock horizontal floor and vertical wall covers of construction as well as technological openings. The gravitation force can be strengthened by a spring force or equivalent technical means.

Applying a force through the cylindrical thrust key 13, which may be, however, formed in another shape as well, inserted into the opening hole 11, the key acts on the lever 9 of the rocker arm 2, and the rocker arm 2 is rotated about the axis of the pin 3 so that the lug 7 slips out from the opposite element 5, and the whole mechanism will thus get into the open position.

Through the force of the cylindrical thrust key 13 on the arm 6 of the rocker arm 2, the lug 7 of the rocker arm 2 slides under the opposite element 5 of the technological opening, thus creating a fixed connection between the cover 10 and this opening. At the time of closing the rocker arm 2, the lever 9 of the rocker arm 2 touches from below the cover 10 of the closing aperture 1. The closing hole 12 may be used to facilitate closing the opening, and the opening hole 11 serves to release the entire mechanism to the open position. For closing and opening the entire mechanism, just a simple cylindrical thrust key without a technologically modified contact interface is sufficient.

### INDUSTRIAL APPLICATION

This invention is suitable for closing or covering all construction and technological apertures, and can be used in dry areas, but especially in areas under water, i.e. for example in septic tanks and pools.

### LIST OF REFERENCE NUMERALS

1—aperture
2—rocker arm
3—pin
4—bracket
5—opposed element
6—arm
7—lug
8—functional part
9—lever
10—cover
11—opening hole
12—closing hole
13—key
14—touch

1. A closure, particularly for closing construction and technological apertures in a vertical and horizontal plane, characterized in that on the bottom side of a cover (10) of a closing aperture (1) a rocker arm (2) is pivotally mounted, the functional part (8) of which is in the closed position of the cover (0) supported on an opposite element (5) which is anchored in the aperture (1).

2. The closure, particularly for closing construction and technological apertures according to claim 1, characterized in that the rocket arm (2) is pivotally mounted on a pin (3) which is anchored by means of brackets (4) on the bottom part of the cover (10).

3. The closure, particularly for closing construction and technological apertures according to claim 1, characterized in that the rocker arm (2) is provided with an arm (6) which in the open position abuts on the bottom wall of the cover (10) as well as with a lug (7), the functional part (8) of which abuts is in the closed position of the cover (10) on the opposite element (5).

4. The closure, particularly for closing construction and technological. apertures according to claim 1, characterized in that the cover (10) is provided with a closing hole (12) for closing the closure and a opening hole (11) for opening the closure.

5. The closure, particularly for closing construction and technological apertures according to claim 1, characterized in that the arm (6) of the rocker arm (2) and the lug (7) of the rocker arm (2) are balanced relative to the pivot (3) so that the closure is maintained in closed position.

6. The closure, particularly for closing construction and technological apertures according to claim 3, characterized in that a spring can be connected to the lug (7) of the rocker arm (2) for locking the lug (7) in the closed position.

7. The closure, particularly for closing construction and technological apertures according to claim 3, characterized in that the functional part (8), the lug (7) of the rocker arm (2) is inclined, so as to form in the closed position of the closure a self-locking connection with the opposite element (5).

8. The closure, particularly for closing construction and technological apertures according to claim 1, characterized in that the pivot axis (3) on which the rocker (2) is mounted, is parallel to the longitudinal axis of the closing hole.

9. The closure, particularly for closing construction and technological apertures according to claim 2, characterized in that the pivot axis (3) on which the rocker (2) is mounted, is parallel to the longitudinal axis of the closing hole.
